(19) United States
(12) Patent Application Publication
(10) Pub. No.: US 2021/0140074 A1
(43) Pub. Date: May 13, 2021

(54) HOLLOW-WOVEN BASE FABRIC

(71) Applicant: SUMISHO AIRBAG SYSTEMS CO., LTD., Matsuura-shi, Nagasaki (JP)

(72) Inventors: Masatoshi YOSHIDA, Matsuura (JP); Teppei HARABAYASHI, Matsuura (JP)

(73) Assignee: SUMISHO AIRBAG SYSTEMS CO., LTD., Matsuura-shi, Nagasaki (JP)

(21) Appl. No.: 16/492,503

(22) PCT Filed: Mar. 6, 2018
(86) PCT No.: PCT/JP2018/008525

§ 371 Date: Sep. 9, 2019

(30) Foreign Application Priority Data
Mar. 10, 2017 (JP) 2017-046820

(51) Int. Cl. D03D 11/00; D03D 1/02; B60R 21/235

(52) U.S. Cl. CPC D03D 11/00; D03D 1/02; B60R 21/235; B60R 21/232; B60R 2021/23509; B60R 2021/23542; D10B 2505/124

(57) ABSTRACT

Provided is a hollow-woven air bag that is capable of maintaining high inner pressure properties even under high pressure after air bag expansion. This hollow-woven base fabric includes: a two-layer structured hollow-woven part (110) that comprises a first fabric layer (120) and a second fabric layer (130); and a joined strip (210) that is formed to be continuous by threads forming the hollow-woven part, wherein first continuous threads (121, 122) form the first fabric layer of the hollow-woven part, and extend to a first joined structure, the first fabric layer includes a first boundary orthogonal thread (123) closest to a boundary with the first joined structure, the first joined structure includes one or more orthogonal threads (223) that extend in a direction orthogonal to the first continuous threads, the first continuous threads are configured such that the respective floating/sinking positional relationships thereof with respect to the first boundary orthogonal thread and the orthogonal threads are not changed at locations between the first boundary orthogonal thread and the orthogonal threads, and second continuous threads (131, 132) are configured similarly.

### TECHNICAL FIELD

The present invention relates to a hollow-woven base fabric. More particularly, the present invention relates to an airbag for automobiles that requires higher airtightness.

### BACKGROUND ART

Most of the passenger automobiles produced today incorporate so-called airbags. The airbags are used to secure safety of passengers by rapidly expanding bag bodies between the passengers of an automobile and an in-vehicle structure of the automobile when the automobile collides with another automobile or with obstacles or when the automobile rollovers. Among the airbags, in particular, a side curtain airbag is responsible for protecting passengers not only when a vehicle collides with an obstacle but also when the vehicle rollovers. Therefore, a bag body having higher airtightness may be required.

It is known that, although an OPW (one-piece woven) hollow-woven base fabric has generally excellent airtightness, when the OPW hollow-woven base fabric is used as an airbag base fabric, high pressure is caused on the inside of the OPW hollow-woven base fabric by gas generated from an inflator and a lot of gas leaks occur from, in particular, a junction band. As one of solutions for suppressing gas leaks from the junction band, an OPW junction band texture that realizes high airtightness is required.

Patent Literature 1 describes an expandable fabric in which double fabric layers are closed by a single basket-woven single fabric layer that sandwiches the double layers. However, there is no detailed description concerning a way of hooking of threads of the single fabric layer forming a boundary part between an expanding portion in the expandable fabric and an expanding part formed by the basket-weaving.

Patent Literature 2 describes a hollow-woven airbag base fabric including, in a boundary part between a bag part and a joining single part A, a joining single part B different in weave texture from the joining single part A, the configuration of the weave texture of the joining single part B taking, at least in one row or more, a configuration in which wefts and/or warps are vertically inverted alternately one by one when viewed from a bag part on a texture diagram. However, with a way of hooking of threads of a boundary part described in Patent Literature 2, it is difficult to suppress leaks of gas due to yarn slippage when high stress in a direction for opening a joining single part is applied from the bag part.

### CITATION LIST

### Patent Literature

PATENT LITERATURE 1: Japanese Patent No. 4256093
PATENT LITERATURE 2: Japanese Patent No. 4190740

### SUMMARY OF INVENTION

### Technical Problem

An object of the present invention is to provide a hollow-woven base fabric including a junction band, the hollow-woven base fabric suppressing yarn slippage of the junction band and maintaining high airtightness as a bag body even when high stress is applied to a joined part according to expansion of the bag body.

### Solution to Problem

In order to solve the problems described above, the present invention provides a hollow-woven base fabric including: a hollow-weave section (110) with a dual-layer structure including a first fabric layer (120) and a second fabric layer (130); and a junction band (210) formed continuously by threads forming the hollow-weave section (110), wherein the junction band (210) includes a first junction structure section (220), the first junction structure section (220) being disposed right next to the hollow-weave section (110), first continuous threads (121, 122) form the first fabric layer (120) of the hollow-weave section (110) and extend to the first junction structure section (220), and second continuous threads (131, 132) form the second fabric layer (130) of the hollow-weave section (110) and extend to the first junction structure section (220), the first fabric layer (120) includes a first boundary perpendicular thread (123) that is closest to a boundary part with the first junction structure section (220), the first boundary perpendicular thread (123) forming the first fabric layer (120) and extending in a direction perpendicular to the first continuous threads (121, 122), the first junction structure section (220) includes one or more perpendicular threads (223) extending in the direction perpendicular to the first continuous threads (121, 122), and floating/sinking positional relationship of the first continuous threads (121, 122) with respect to the first boundary perpendicular thread (123) and the perpendicular threads (223) is not reversed between the first boundary perpendicular thread (123) and the perpendicular threads (223), and the second fabric layer (130) includes a second boundary perpendicular thread (133) that is closest to a boundary part with the first junction structure section (220), the second boundary perpendicular thread (133) forming the second fabric layer (130) and extending in a direction perpendicular to the second continuous threads (131, 132), and floating/sinking positional relationship of the second continuous threads (131, 132) with respect to the second boundary perpendicular thread (133) and the perpendicular threads (223) is not reversed between the second boundary perpendicular thread (133) and the perpendicular threads (223).

In another embodiment of the present invention, the junction band (210) further includes a second junction structure section (221), and the second junction structure section (221) is disposed next to the first junction structure section in order from the hollow-weave section (110) and has a single-layer structure.

In another embodiment of the present invention, the hollow-woven base fabric includes a junction band including a hollow-weave texture on the farther outside than the first junction structure section (220) in order from the hollow-weave section (110).

In another embodiment of the present invention, an air-impermeable material is imparted to the hollow-woven base fabric.

### BRIEF DESCRIPTION OF DRAWINGS

FIG. 1 is a diagram illustrating an example of a form of an expandable hollow-woven base fabric.

FIG. 2 is a schematic cross-sectional view (a) and a weave texture diagram (b) conceptually illustrating a boundary part weave structure generally used at present.

FIG. 3 is cross-sectional view conceptually illustrating a junction structure section at the time when gas is filled in a bag body of a weave structure generally used at present and a hollow-weave section expands.

FIG. 4 is a schematic cross-sectional view (a) and a weave texture diagram (b) conceptually illustrating an example of the present invention.

FIG. 5 is a cross-sectional view conceptually illustrating the junction structure section at the time when gas is filled in a bag body in the example of the present invention and the hollow-weave section expands.

FIG. 6 is a schematic cross-sectional view (a) and a weave texture diagram (b) conceptually illustrating a weave texture used in an example 1.

FIG. 7 is a conceptual cross-sectional view (a) and a weave texture diagram (b) conceptually illustrating a weave texture used in a comparative example 1.

FIG. 8 is a graph comparing air leak amounts in the example 1 and the comparative example 1.

FIG. 9 is a diagram specifically illustrating how test pieces of tests carried out in an example 2 and a comparative example 2 are taken.

FIG. 10 is a diagram specifically illustrating how the test pieces of the tests carried out in the example 2 and the comparative example 2 are attached.

### DESCRIPTION OF EMBODIMENTS

Examples of preferred embodiments of the present invention are explained below with reference to the drawings. Matters described herein, in particular, a weave structure, a weave texture, and a name and a shape of the weave texture are described in order to facilitate understanding of the gist of the present invention and do not limit embodiments of the present invention.

A weave structure of the present invention is applicable to a part or all of junction bands of a hollow-woven base fabric and may be applied to various junction bands having various shapes, such as junction bands continuing at an angle with respect to wefts and warps, junction bands arranged in a curved line manner, bent junction bands, and the like. In particular, when the weave structure is used for an airbag, it is preferable to apply the weave structure in a junction band part on which stress is concentrated due to internal pressure.

FIG. 1 is a diagram illustrating an example of a form of an expandable hollow-woven base fabric. The expandable hollow-woven base fabric includes an expandable double-layer structure hollow-weave section 110 and a junction band 210 disposed at the outer edge portion of the hollow-weave section.

FIG. 2(a) is a schematic cross-sectional view schematically illustrating a weave structure of a boundary part generally used at present. FIG. 2(a) schematically illustrates a weave structure of a boundary part taken along a line A-A′ of FIG. 1 and is adopted as an example in order to clarify a difference from the present invention.

As illustrated in FIG. 2, in a hollow weave closing structure generally used at present, when continuous threads are hooked on a first junction structure section 220 from the hollow-weave section 110, threads are generally hooked such that upper and lower threads are reversed in the boundary part. Consequently, it is considered that a boundary between the hollow-weave section and a junction structure section is densely closed and internal pressure maintenance properties are also improved. In fact, when internal pressure applied to a bag body is low, it is possible to obtain high internal pressure maintenance properties with this structure.

However, when gas is injected into the inside of the bag body having the structure illustrated in FIG. 2 and high pressure is applied, gaps 320 and 330 are formed between the hollow-weave section and the junction structure section as illustrated in FIG. 3 and the gas leaks from the gaps. Therefore, the internal pressure maintenance properties are suddenly deteriorated when high internal pressure is applied to the bag body.

FIG. 4(a) is a schematic cross-sectional view illustrating an example of the present invention and schematically illustrates the weave structure of the boundary part along the line A-A′ of FIG. 1.

The hollow-woven base fabric of the present invention includes a double-layer structure hollow-weave section 110 including a first fabric layer 120 and a second fabric layer 130 and a junction band 210 continuously formed by threads forming the hollow-weave section 110. The junction band 210 includes the first junction structure section 220. The first junction structure section 220 is disposed right next to the hollow-weave section 110. First continuous threads 121 and 122 form the first fabric layer 120 of the hollow-weave section 110 and extend to the first junction structure section 220. Second continuous threads 131 and 132 form the second fabric layer 130 of the hollow-weave section 110 and extend to the first junction structure section 220. The first fabric layer 120 includes a first boundary perpendicular thread 123 that is closest to a boundary part with the first junction structure section 220. The first boundary perpendicular thread 123 forms the first fabric layer 120 and extends in a direction perpendicular to the first continuous threads 121 and 122. The first junction structure section 220 includes one or more perpendicular threads 223 extending in the direction perpendicular to the first continuous threads 121 and 122. Floating/sinking positional relationship of the first continuous threads 121 and 122 with respect to the first boundary perpendicular thread 123 and the perpendicular threads 223 is not reversed between the first boundary perpendicular thread 123 and the perpendicular threads 223. The second fabric layer 130 includes a second boundary perpendicular thread 133 that is closest to a boundary part with the first junction structure section 220. The second boundary perpendicular thread 133 forms the second fabric layer 130 and extends in a direction perpendicular to the second continuous threads 131 and 132. Floating/sinking positional relationship of the second continuous threads 131 and 132 with respect to the second boundary perpendicular thread 133 and the perpendicular threads 223 is not reversed between the second boundary perpendicular thread 133 and the perpendicular threads 223.

FIG. 5 illustrates a schematic cross-sectional view schematically illustrating a junction structure section at the time when gas is filled in the bag body and the hollow-weave section expands, according to the present invention.

In the present invention, when the hollow-weave section expands as illustrated in FIG. 5, the first boundary perpendicular thread 123 closes the gap 320 formed between the first fabric layer 120 and the first junction structure section 220 and the second boundary perpendicular thread 133 closes the gap 330 formed between the second fabric layer 130 and the first junction structure section 220. Consequently, an effect of structurally suppressing deterioration in internal pressure maintenance properties is obtained.

In the present invention, it is important to adopt a structure in which vertical positional relationship between the continuous threads do not change when the continuous threads are hooked on the first junction structure section from the hollow-weave section. The number of threads on which the continuous threads are hooked first in the first junction structure section is not particularly limited, that is, may be one or more. However, when airtightness is regarded as particularly important, one to four threads are preferable, and one thread illustrated in FIG. 4 or two threads illustrated in FIG. 6 are more preferable.

A second junction structure section 221 disposed continuously to the first junction structure section 220 when viewed from the hollow-weave section may be appropriately used according to how the first continuous threads 121 and 122 and the second continuous threads 131 and 132 are used. However, for the purpose of suppressing a yarn shift, it is more preferable to use a plain weave, which is a tight single-layer structure texture, a rib weave with continuous threads, a 2/2 basket weave, a 2/2 twill, or mixture of these weave textures.

In another embodiment of the present invention, in the junction band 210, a hollow-weave texture may be disposed in a junction band on the farther outside than the first junction structure section when viewed from the hollow-weave section. By disposing a hollow weave in a junction band portion on the farther outside than the first junction structure section, it is possible to reduce a difference in thread density between the junction band and the hollow-weave section on the junction band inner side. There are effects such as improvement of weaving performance and crease suppression during drying in a scouring process and in imparting an air-impermeable material when the hollow-woven base fabric of the present invention is processed as an airbag.

The width of the hollow weave put in the junction band may be appropriately selected according to target width of the junction band. However, approximately two to twenty follow weaves per one surface of a bag body are preferable. Approximately four to twelve hollow weaves are more preferable when weaving performance and a function of the airbag are considered.

The fineness of warps and wefts of the base fabric used in the present invention may be selected from threads having in thickness usually used in the base fabrics for airbags, that is, a range of 150 to 1000 dtex, and preferably may be set in a range of 235 to 700 dtex. When the fineness is smaller than 150 dtex, it tends to be difficult to obtain strength required for airbag. When the fineness exceeds 1,000 dtex, a unit weight tends to be too large.

The strength of the threads used in the present invention may be 7 cN/dtex or more, and preferably 8 cN/dtex or more. The thickness of each single thread is preferably for example, within a range of 0.5 to 6 dtex. Further, a cross-sectional shape of the single thread may be appropriately selected within a range that does not interfere with the production of the base fabric and the physical properties of the base fabrics. For example, the cross-sectional shape of the single thread may be round shapes, oval shapes, flat shapes, polygonal shapes, hollow shapes, and other different shapes. In addition, a plurality of threads having different fineness, cross-sectional shapes, or the like may be integrated by doubling, twisting, or other processing.

The base fabric used in the present invention preferably has a unit weight of 260 g/m² or less and a tensile strength of 650 N/cm or more. If the unit weight and the tensile strength are within these ranges, the base fabric is considered to be light weight and has excellent physical properties. Note that the term “unit weight” refers to the weight of a base fabric in an unprocessed state before application of an air-impermeable material or the like, which will be described later.

When the unit weight exceeds 260 g/m², the weight of the airbag increases and it is difficult to achieve a desired reduction in weight. When the tensile strength is smaller than 650 N/cm, there is a possibility that physical properties necessary for the airbag cannot be achieved.

In addition, the base fabric used in the present invention preferably has a cover factor of 700 or more, and more preferably 750 or more. The cover factor is an index indicating the compactness of the weaving structure.

The cover factor (CF) is generally calculated by multiplying the weaving densities N (number/cm) and thicknesses D (dtex) of respective warps and wefts of the base fabric and is represented by the following expression:

CF=Nw×√Dw+Nf×√Df

where Nw and Nf are weaving densities (number/cm) of warps and wefts, and Dw and Df are thicknesses (dtex) of warps and wefts.

The hollow weave of the present invention can be manufactured by a loom equipped with a jacquard device. A weft insertion method may be appropriately selected from various looms used for manufacturing normal industrial base fabrics. The weft insertion method may be selected from a shuttle loom, a water jet loom, an air-jet loom, a rapier loom, a projectile loom, and the like.

Fiber threads configuring the base fabric for airbags of the present invention may be natural fibers, chemical fibers, inorganic fibers, or the like, and are not particularly limited. Among the fibers, synthetic fiber filaments having general versatility are preferable from the viewpoints of a manufacturing process of the base fabric, physical properties of the base fabric, and the like. For example, one or more kinds of thread fibers may be appropriately selected from fibers such as: aliphatic polyamide fibers including Nylon 6, Nylon 66, Nylon 46, Nylon 610, and Nylon 612, or copolymers and mixtures of these; copolymer polyamide fibers of aliphatic amine and aromatic carboxylic acid represented by Nylon 6T, Nylon 61, and Nylon 9T; polyester fibers including polyethylene terephthalate, polytrimethylene terephthalate, polybutylene terephthalate, and polyethylenenaphthalate, or copolymers and mixtures of these; ultrahigh molecular weight polyolefin-based fibers; chlorine-containing fibers including vinylene and polyvinyl chloride; fluorine-based fibers including polytetrafluoroethylene; polyacetal-based fibers; polysulfone-based fibers; polyphenylene sulfide-based fibers (PPS); polyether ether ketone-based fibers (PEEK); wholly aromatic polyamide-based fibers; wholly aromatic polyester-based fibers; polyimide-based fibers; polyether imide-based fibers; poly para-phenylene benzobisoxazole-based fibers (PBO); vinylon-based fibers; acrylic fibers; cellulosic fibers; silicon carbide-based fibers; alumina-based fibers; glass-based fibers; carbon-based fibers; and steel-based fibers. Among the fibers, the Nylon 66 fibers and the polyester-based fibers are preferable from the viewpoints of physical properties, durability, heat resistance, and the like. The polyester-based fibers and the Nylon 6 fibers are also preferable from the viewpoint of recycling.

In order to improve spinnability, processability, and durability, one or more or two or more kinds of additives among various additives generally in use, may be used. Examples of the additives include a heat-resistant stabilizer, an antioxidant, a light-resistant stabilizer, an age inhibitor, a lubricant, a smoothing agent, a pigment, a water-repellent agent, an oil-repellent agent, a masking agent such as titanium oxide, a luster imparter, a flame retarder, and a plasticizer. Treatment such as twisting, bulking, crimping, winding, and pasting may also be applied. Furthermore, as forms of the threads, besides long-fiber filaments, a staple spun thread, a composite thread thereof, and the like may be used.

The base fabric used in the present invention preferably includes an air-impermeable material because airtightness of the airbag can be secured. The air-impermeable material is, for example, a material that substantially inhibits passage of air as explained below. Air impermeable means that a measurement value is zero in the 8.27.1A method (Frazier method) in JIS L1096 “Testing methods for woven and knitted fabrics”. The material is imparted to a bse fabric from one side or both sides of the fabric by a method explained below. The air-impermeable material may be interposed in any place such as the surface of the base fabric, intersections of thread bundles configuring the base fabric, or gap portions between fiber single threads.

The material may be a material usually used in a base fabric for airbags and may be a material satisfying heat resistance, abrasion resistance, adhesion to the base fabric, flame retardancy, non-adherence, and the like. For example, among silicone-based resin or rubber, polyurethane-based resin or rubber (including silicone-modified and fluorine-modified resin or rubber), fluorine-based resin or rubber, chlorine-based resin or rubber, polyester-based resin or rubber, polyamide-based resin or rubber, epoxy-based resin, vinyl-based resin, urea-based resin, phenol-based resin, olefin-based resin, and the like, one or more kinds may be used. Among these kinds of resin or rubber, silicone resin, polyamide-based resin, polyester-based resin, polyurethane-based resin, or the like is preferable from the viewpoints of heat resistance and flame retardancy.

Examples of a method for imparting the air-impermeable material to the base fabric include 1) a coating method (including knife, kiss, reverse, comma, slot die, and lip coating), 2) an impregnating method, 3) a printing method (including screen, roll, rotary, and gravure printing), 4) a transfer method (transfer), and 5) a lamination method and combined use of the methods. Among the methods, the coating method or the lamination method is preferable because an effect of maintaining internal pressure is high.

An amount of the air-impermeable material imparted to the base fabric is preferably 10 to 150 g/m² for one side and is more preferably 50 to 100 g/m². When the air-impermeable material is formed in a layer shape, the thickness of the air-impermeable material is preferably 10 nm or more. When the amount of the air-impermeable material imparted to the base fabric is less than 10 g/m² for one side or when the thickness of the layer is smaller than 10 μm, it tends to be difficult to obtain necessary airtightness.

In order to improve processability, adhesion, surface characteristics, durability, or the like, besides a main material, one or more kinds of additives may be selected from various additives generally in use and may be mixed into the material. Examples of the additives include a crosslinking agent, an adhesion imparting agent, a reaction accelerator, a reaction retarding agent, a heat-resistant stabilizer, an antioxidant, a light-resistant stabilizer, an age inhibitor, a lubricant, a smoothing agent, an anti-tack agent, a pigment, a water-repellent agent, an oil-repellent agent, a masking agent such as titanium oxide, a luster imparter, a flame retarder, and a plasticizer.

The type of the material as a liquid may be appropriately selected from a non-solvent type, a solvent type, a water-dispersion type, a water-emulsifiable type, a water soluble type, and the like according to an application amount, an application method, processability, stability of the material, required properties, and the like.

Various pretreatment agents for enhancing adhesion to the base fabric, bonding improvers, and the like may be added to the material or pretreatment such as priming may be applied to the surface of the base fabric in advance. Furthermore, in order to enhance physical properties of the material or to impart heat resistance, aging resistance, oxidation resistance, and the like to the material, drying, crosslinking, heat treatment such as vulcanization, pressure heat treatment, and high energy treatment (such as high frequency, electron beam, and ultraviolet treatment) , and the like may be performed after the material is imparted to the base fabric.

When laminating is performed, a material to be laminated is not particularly limited. Known substances are usable as the material. The known substances include homopolymers or copolymers such as polyester-based resin, polyamide-based resin, polyolefin-based resin, and polyurethane-based resin, copolymers with other kinds of materials, and modified materials are usable. Known methods are usable for the laminating. The known methods include treating these substances with adhesive imparting materials such as polyolefin-based resin in advance and disposing an adhesive layer on one surface of a film and treating the base fabric. As thermoplastic resin used for an adhesive layer, for example, homopolymers or copolymers such as polyamide-based resin, polyolefin-based resin, and polyurethane-based resin, copolymers with other kinds of materials, and modified materials having melting points of 200° C. or less are preferable.

A laminating method is not particularly limited either. Known methods are usable as the laminating method. The known methods include a dry laminate method for applying an adhesive on the base fabric or the film and drying the adhesive to evaporate a solvent and thereafter thermocompression-bonding the base fabric or film, a wet laminate method for applying a water-soluble adhesive to the base fabric or the film to stick the base fabric or the film and thereafter drying the adhesive, an extrusion laminate method for extruding melted resin onto the base fabric and laminating the resin, and a thermal laminate method for manufacturing a resin layer formed in a film shape and then laminating and thermocompression-bonding the resin layer. However, the thermal laminate method is preferable from the viewpoint of processing cost and environment.

The thickness of a laminate coating material is not particularly limited either, but may be appropriately set between 10 μm and 100 μm according to a purpose. In general, 10 to 40 μm is preferable in a curtain bag that does not assume automobile rollovers and 40 to 100 μm is preferable in a curtain bag of a type that is a hollow-woven bag and assumes passenger protection during automobile rollovers.

In the case of hollow weave, usually, it is preferable to manufacture wefts using sized original yarn, and in order to remove the oil agent, sizing agent and the like adhering to the original yarn prior to coating such that the adhesiveness between the coating agent or the laminate material and the base fabric is not hindered, scouring is preferably performed by a jigger scouring machine or a continuous scouring machine including a plurality of scouring tanks. After the scouring, the base fabric is dried by a cylinder drier or the like. After the drying, the base fabric may be supplied as it is to the next coating process or laminate process. However, it is preferable to subsequently heat-set the base fabric after the scouring and the drying in order to adjust dimensions and weaving density.

After the coating or the laminating, the base fabric is cut into predetermined dimensions and a predetermined shape by a laser cutter, accessories such as a strap for fixing an airbag is sewn on the base fabric, and reinforcement of an attaching section to a vehicle body and the like are performed to complete a product.

Specifications, a shape, and a capacity of the airbag of the present invention may be selected according to a part where the airbag is disposed, a use of the airbag, a storage space of the airbag, passenger shock absorption performance, an output of an inflator, and the like. To limit projection to the side of the passenger or control the thickness upon expansion, a cord or a gas flow adjusting fabric may be provided on the airbag inner side or a belt-like fabric or a pressing fabric called flap may be provided on the airbag outer side.

In the hollow weave used in the present invention, the texture of the joined part near the boundary with the expanding part is not particularly limited. However, basket weave, reversible figured double weave, plain weave, and the like may be combined to perform appropriate repetition of the basket weave, the reversible figured double weave, the plain weave, and the like.

In addition, depending on the characteristics of the inflator to be used, a heat-resistant protective cloth for protection from hot gas or a mechanical reinforcing cloth may be provided around the inflator ejection port. For these protective cloths and reinforcing cloths, heat-resistant fiber materials such as wholly aromatic polyamide fibers, wholly aromatic polyester fibers, PBO fibers, polyimide fibers, fluorine-containing fibers and the like may be used as the cloth itself, and the base fabric manufactured separately using base fabric that are the same as or thicker than the base fabric for the airbag body may be used. In addition, the base fabric applied with the heat resistant coating agent may be used.

As a folding method when storing the airbag, folding screen folding horizontally and vertically symmetrical from the center as in a bag for a driver's seat, folding for pressing and shrinking the airbag from many directions toward the center, roll folding for a passenger's seat airbag, bellows folding, folding screen-like zigzag folding, or combined use of the foregoing, alligator folding as in a seat-incorporated side bag, roll folding or bellows folding as in a side curtain airbag, or the like may be used.

The bag body of the present invention can be used in uses in passenger cars, commercial cars, buses, motorbikes, and the like such as various bags for passenger protection, for example, a side bag and a side curtain airbag for front collision and side collision in a driver's seat and a passenger's seat, a headrest bag for rear seat protection and protection from rear end collision, a knee bag and a foot bag for left and foot protection, a mini bag for infant protection (a child seat), a bag body for an air belt, an a bag for pedestrian protection. Besides, the bag can be applied to many uses such as ships, trains and electric trains, airplanes, and amusement facilities if the bag body is functionally satisfactory.

### EXAMPLES

The present invention is more specifically explained below based on examples.

Hollow-woven base fabrics according to the examples and comparative examples were prepared to have a hollow-weave section with a two-layer plain weave texture, under the same conditions described below except for the structure of a junction band.

Preparation conditions: 470 dtex/72f Nylon-6.6 fibers with thread strength of 40 N/number and 21% ductility were sized with a polyacrylic acid sizing agent, and then were arranged so that 10,000 fibers were wound around a warp beam. Next, a hollow-woven base fabric with a hollow-weave section and a junction band having a shape illustrated in FIG. 1 was weaved with 57 warps/inch and 49 wefts/inch by an air jet loom equipped with a jacquard device for warp control. Next, the fabric was soaked in aqueous solution containing 7.4 g/L sodium hydroxide at 60° C., put in a steam tank at 80° C. for 30 seconds, and then was water-washed for 1 minute at 90° C. After being dried for 1 minute with a heating roller at 100° C., the fabric was heat-set by a tenter at 150° C. for 30 seconds, and wound up. Thereafter, 55 g of silicone resin was imparted to the base fabric surface by a knife coat method.

Note that a texture diagram illustrated in the examples and the comparative examples is only one example. A plurality of combinations of hollow weaves having the same way of hooking of threads in a boundary part and closing textures are present according to combinations of hollow-weave textures and closing textures. Therefore, embodiments of the present invention are not limited by the texture diagrams disclosed in the examples.

### Example 1

In FIG. 6, a schematic cross-sectional view (a) and a weave texture diagram (b) of a weave structure used in an example 1 are illustrated. As a junction band in the example 1, upper and lower threads were hooked on two perpendicular threads without being reversed in a boundary part with a first junction structure section from a hollow-weave section side and, thereafter. a 2/2 basket weave texture was used in a second junction structure section.

### Comparative Example 1

FIG. 7 illustrates a schematic cross-sectional view (a) and a weave texture diagram (b) of a weave structure used in a comparative example 1. As a junction band in the comparative example 1, upper and lower threads were reversed and hooked on two perpendicular threads in a boundary part with a first junction structure section from a hollow-weave section side and, thereafter, a 2/2 basket weave texture was used in a second junction structure section.

As it is seen when FIG. 6(b) and FIG. 7(b) are compared, the upper thread and the lower thread of the 2/2 basket weave texture are reversed in a closing section on the texture diagram when the example 1 and the comparative example 1 are compared. The textures of the example 1 and the comparative example 1 were applied to a rectangular bag body having a side length of 500 mm illustrated in FIG. 1, a bag body was created by the manufacturing method explained above, pressure was raised to 0 to 100 kPa at an interval of 10 kPa by compressed air, air leak amounts were measured at stages when the pressures of the textures stabilized.

A graph of comparison of the air leak amounts in the example 1 and the comparative example 1 is illustrated in FIG. 8. As it is evident from the graph, the air leak amount in the comparative example 1 is low, which means excellent internal pressure maintenance properties in a low-pressure region of 0 to 50 kPa. However, in the comparative example 1, when internal pressure exceeds 50 kPa, yarn slippage of a base fabric increases and the air leak amount suddenly increases. On the other hand, in the example of the present invention, yarn slippage is suppressed and an increase in the air leak amount can be suppressed in the high-pressure region exceeding 50 kPa.

### Example 2

In an example 2, the upper and lower threads are hooked on one perpendicular thread without being revered in the boundary part with the first junction structure section from the hollow-weave section side by the junction band texture illustrated in FIG. 4(b). Thereafter, a 2/2 basket weave texture was used in the second junction structure section.

### Comparative example 2

In a comparative example 2, the upper and lower threads are reversed and hooked on one perpendicular thread in the boundary part with the first junction structure section from the hollow-weave section side by the junction band texture illustrated in FIG. 2(b). Thereafter, a 2/2 basket weave texture was used in the second junction structure section.

The textures of the example 2 and the comparative example 2 were applied to a rectangular bag body having a side length of 500 mm illustrated in FIG. 1, a bag body was created by the manufacturing method explained above, and air permeability of a junction band was measured by a method explained below.

First, as illustrated in FIG. 9, a bag body was cut by a semicircle having a radius of 180 mm, a linear side of which was a junction band portion, a seal agent was applied at width of 30 mm to the inner side of a base fabric in a double cut portion indicated by a gray color and the base fabric was bonded to prevent gas from leaking from a space between an upper fabric and a lower fabric. Thereafter, as illustrated in FIG. 10, a bonding portion of the bag part base fabric was vertically sandwiched by two metal plates having thickness of 10 mm, in which a hole having a radius of 150 mm was opened, and the metal plates were fixed by bolts to prevent the base fabric from shifting. Compressed air was injected into a semicircular hollow weave sample attached to the metal plates in this way to raise internal pressure to an initial pressure of 100 kPa. Thereafter, the injection of the compressed air was stopped and pressure after 30 seconds was measured to compare air permeabilities of junction sections. A result of the comparison is illustrated in Table 1.

TABLE 1

| | Initial pressure | Internal pressure |
|---|---|---|
| | (kPa) | after 30 seconds (kPa) |
| Example 2 | 100 | 75 |
| Comparative example 2 | 100 | 66 |

As illustrated in Table 1, whereas the internal pressure after 30 seconds in the comparative example 2 was 66 kPa, the internal pressure of 75 kPa was maintained in the example 2 in which the present invention is used. Therefore, superiority of the present invention was proved.

As explained above, according to the present invention, it is possible to obtain a hollow-woven base fabric including a junction band that can keep high internal pressure maintenance properties in a relatively high pressure region. It is possible to obtain a hollow-woven base fabric that can suppress gas leaks from a junction band, in particular, in uses in which high pressure is applied to the junction band and uses in which high-pressure fluid is introduced into a hollow-weave section, for example, in an airbag of an automobile and a gas hose, which is a constituent member of the airbag.

### REFERENCE SIGNS LIST

110 hollow-weave section
120 first fabric layer
121, 122 first continuous thread
123 first boundary perpendicular thread
130 second fabric layer
131, 132 second continuous thread
133 second boundary perpendicular thread
210 junction band
220 first junction structure section
221 second junction structure section
223, 223′ perpendicular thread extending to the first junction structure section
320, 330 gap formed between the hollow-weave section and the junction structure section during high pressure

1. A hollow-woven base fabric comprising: a hollow-weave section (110) with a dual-layer structure including a first fabric layer (120) and a second fabric layer (130); and a junction band (210) formed continuously by threads forming the hollow-weave section (110), wherein
the junction band (210) includes a first junction structure section (220), the first junction structure section (220) being disposed immediately next to the hollow-weave section (110), first continuous threads (121, 122) form the first fabric layer (120) of the hollow-weave section (110) and extend to the first junction structure section (220), and second continuous threads (131, 132) form the second fabric layer (130) of the hollow-weave section (110) and extend to the first junction structure section (220),
the first fabric layer (120) includes a first boundary perpendicular thread (123) that is closest to a boundary part with the first junction structure section (220), the first boundary perpendicular thread (123) forming the first fabric layer (120) and extending in a direction perpendicular to the first continuous threads (121, 122), the first junction structure section (220) includes one or more perpendicular threads (223) extending in the direction perpendicular to the first continuous threads (121, 122), and floating/sinking positional relationship of the first continuous threads (121, 122) with respect to the first boundary perpendicular thread (123) and the perpendicular threads (223) is not reversed between the first boundary perpendicular thread (123) and the perpendicular threads (223), and
the second fabric layer (130) includes a second boundary perpendicular thread (133) that is closest to a boundary part with the first junction structure section (220), the second boundary perpendicular thread (133) forming the second fabric layer (130) and extending in a direction perpendicular to the second continuous threads (131, 132), and floating/sinking positional relationship of the second continuous threads (131, 132) with respect to the second boundary perpendicular thread (133) and the perpendicular threads (223) is not reversed between the second boundary perpendicular thread (133) and the perpendicular threads (223).

2. The hollow-woven base fabric according to claim 1, wherein the junction band (210) further includes a second junction structure section (221), and the second junction structure section (221) is disposed next to the first junction structure section in order from the hollow-weave section (110) and has a single-layer structure.

3. The hollow-woven base fabric according to claim 1, wherein the hollow-woven base fabric includes a junction band including a hollow-weave texture on the farther outside than the first junction structure section (220) in order from the hollow-weave section (110).

4. The hollow-woven base fabric according to claim 1, wherein an air-impermeable material is imparted to the hollow-woven base fabric.
